(19) United States
(12) Patent Application Publication
(10) Pub. No.: US 2021/0404214 A1
(43) Pub. Date: Dec. 30, 2021

(54) DOOR STRIKE

(71) Applicant: Oldcastle BuildingEnvelope, Inc., Dallas, TX (US)

(72) Inventors: Conor McDonald, Cleveland, OH (US); Jeffrey James Phillips, Grand Rapids, MI (US)

(21) Appl. No.: 17/356,481

(22) Filed: Jun. 23, 2021

Related U.S. Application Data
(60) Provisional application No. 63/043,556, filed on Jun. 24, 2020.

(51) Int. Cl. E05B 15/02

(52) U.S. Cl. CPC E05B 15/0205; E05B 2015/023

(57) ABSTRACT

Described is a strike plate assembly for installing in a door frame and methods thereof. The strike plate assembly may include a first member and a second member. When installed, the first member may be attached to a first door fame surface via a first attachment member and the second member may be attached to a second door frame surface via a second attachment member such that the strike plate assembly may be easily movable along the door frame.

### REFERENCE TO RELATED APPLICATION

This application claims the benefit of U.S. Provisional Application Ser. No. 63/043,556, titled “DOOR STRIKE” and filed Jun. 24, 2020, the content of which is hereby incorporated.

### FIELD OF THE INVENTION

The field of the invention relates to door strikes for use in door systems and methods of installing thereof.

### BACKGROUND

Modern doors typically utilize a strike plate component. Strike plates are mounted on a door frame and receive a corresponding door latch, typically, a spring-loaded latch, including spring latches, dead latches, ball catches, and roller catches. Conventional strike plates generally include a substantially flat portion, which is attached to a door frame, and a curved, ramp-like portion, which is configured to provide a sloped surface to engage the latch as the door is closed. During the process of closing the door, a spring-loaded latch transitions from an extended position to a retracted position as it moves along the curved portion of the strike plate. Ultimately, the retracted latch encounters an aperture in the strike plate that allows the latch to re-extend into the aperture so as to provide mechanical resistance against movement of the door in the open direction. To open the door, the latch must be retracted again by, for example, turning the door knob or handle.

The strike plate is a key component of a latch system because it helps to protect the door frame from friction caused by the latch during normal use. However, the strike plate must be firmly secured to the door frame in order to withstand the repeated forces resulting from its interaction with the latch. For example, every time the door is opened or closed (but, particularly, when the door is closed), the latch imparts a pushing force on the curved portion of the strike plate, the leading edge of which extends away from the door frame. Such pushing force causes a moment that exerts a pulling force on the substantially flat portion of the strike plate.

To withstand this moment, the conventional strike plates rely on screws to secure the substantially flat portion of the strike plate to the door frame. This design requires drilling multiple, generally at least two holes, in addition to the hole needed to accommodate the latch's extension once it enters the strike plate aperture. For softer materials such as wood or plastic, self-tapping screws may be used to avoid pre-drilling holes, but, for harder materials such as metal, it may be more desirable for the holes to be pre-drilled, which further requires pre-determining precise locations of the holes. Even then, exposure to the repeated forces of opening and closing the door may cause the screws to gradually become loosened, dislodged, or otherwise unsecured over time, thereby requiring periodic tightening or replacement to maintain the functionality of the latch system. In some instances, such movement of the screws over time may result in one or more of the holes becoming misshapen or deformed such that one or more screws simply spin in place and cannot be re-tightened, thus requiring a more complicated, often makeshift, type of repair that may or may not be feasible or successful, such as plugging the hole, using a larger-diameter screw, installing a longer screw at an angle, using a strike plate with a different hole pattern, or moving the strike plate. Moreover, conventional strike plates are not easily movable along the door frame. Therefore, if a mistake is made during installation, a user must completely begin anew, thereby prolonging the installation process.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments, a strike plate assembly is configured to be installed in a door and includes a first member, a second member, and a cover member. The first member may include a first surface, a second surface opposite the first surface, at least one first attachment member, and at least one aperture. The first attachment member may be disposed on the second surface. The second member may include a first surface, a second surface opposite the second surface, and at least one second attachment member disposed on the second surface. The cover member may be positioned on the second surface of the first member such that the cover member substantially covers the aperture. The first member may be positioned substantially perpendicular to the second member. When the strike plate assembly is installed, the first attachment member may attach the first member to a door frame first surface and the second attachment member may attach the second member to a door frame second surface.

In some embodiments, the strike plate assembly may include a gasket disposed on the door frame. When installed, the gasket may contact the first member.

In some embodiments, the first member has a first length and the second member has a second length. The first length may be greater than the second length.

In some embodiments, the first member includes two first attachment members. One of the first attachment members may be positioned above the aperture and the other first attachment member may be positioned below the aperture.

In some embodiments, each of the first attachment member and the second attachment member is an adhesive attachment.

When installed, the cover member may be positioned within the aperture.

According to certain embodiments, a strike plate assembly for a door frame includes a first member positioned substantially perpendicular to a second member. The first member may include an exterior surface, an interior surface opposite the exterior surface, and at least one aperture. The second member may include an exterior surface and an interior surface opposite the exterior surface. An angle between the first member and the second member may be approximately 90 degrees.

In some embodiments, an adhesive attachment may join the interior surface of the first member and the interior surface of the second member to the door frame.

According to certain embodiments, a strike plate assembly may include a first member having an aperture, a second member positioned substantially perpendicular to the first member, and at least one attachment member. A method for installing a strike plate assembly on a door frame includes forming an aperture within a surface of the door frame, positioning the strike plate assembly on the door frame, and applying pressure to the strike plate assembly to secure the strike plate assembly to the door frame. The strike plate assembly may be positioned on the door frame such that the aperture is positioned over the aperture formed within the door frame. Moreover, the strike plate assembly may be secured to the door frame via the attachment member.

In some embodiments, the attachment member includes at least one first attachment member disposed on the first member and at least one second attachment member disposed on the second member. Each of the first attachment member and the second attachment member may be an adhesive attachment.

In some embodiments, a cover member may be positioned within the aperture formed within the door frame.

In some embodiments, positioning the strike plate assembly on the door frame includes positioning the first member of the strike plate assembly on the door frame.

In some embodiments, applying pressure to the strike plate assembly includes applying pressure to a surface of the first member to secure the first member to a door frame first surface. Similarly, applying pressure to the strike plate assembly may include applying pressure to a surface of the second member to secure the second member of a door frame second surface.

### BRIEF DESCRIPTION OF THE DRAWINGS

FIGS. 1A-1C are perspective views of a strike plate assembly assembly according to certain embodiments of the present invention.

FIGS. 2A is a top view of the strike plate assembly of FIGS. 1A-1C according to certain embodiments of the present invention.

FIGS. 2B is an isometric view of the strike plate assembly of FIGS. 1A-1C according to certain embodiments of the present invention.

FIGS. 2C is a side view illustrating a first member of the strike plate assembly of FIGS. 1A-1C according to certain embodiments of the present invention.

FIGS. 2D is another side view illustrating a second member of the strike plate assembly FIGS. 1A-1C according to certain embodiments of the present invention.

FIGS. 3A is another side view illustrating the first member of the strike plate assembly of FIGS. 1A-1C according to certain embodiments of the present invention.

FIGS. 3B is another side view illustrating the second member of the strike plate assembly of FIGS. 1A-1C according to certain embodiments of the present invention.

FIG. 4 is a perspective view of a cover member of the strike plate assembly of FIGS. 1A-1C according to certain embodiments of the present invention.

FIG. 5A is a top view of the cover member of FIG. 4 according to certain embodiments of the present invention.

FIG. 5B is a side view of the cover member of FIG. 4 according to certain embodiments of the present invention.

FIG. 5C is a cross-sectional view of the cover member of FIG. 5A according to certain embodiments of the present invention.

FIG. 6A is a front view of the strike plate assembly of FIGS. 1A-1C installed on in a door frame according certain embodiments of the present invention.

FIG. 6B is a cross-sectional view of the strike plate assembly of FIGS. 6A installed on in a door frame according certain embodiments of the present invention.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

As used herein, the terms “comprises,” “comprising,” “includes,” “including,” “has,” “having,” or any other variation thereof, are intended to cover a non-exclusive inclusion. For example, processes, methods, articles, or apparatuses that comprise a list of elements are not necessarily limited to only those elements but may include other elements not expressly listed or inherent to such processes, methods, articles, or apparatuses. Further, unless expressly stated otherwise, the word “or” means the inclusive “or.” For example, a condition A or B is satisfied by any one of the following: A is true (or present) and B is false (or not present), A is false (or not present) and B is true (or present), both A and B are true (or present).

According to certain embodiments of the present invention, a strike plate assembly 100 configured to be installed in a door frame 102 comprises a first member 10.

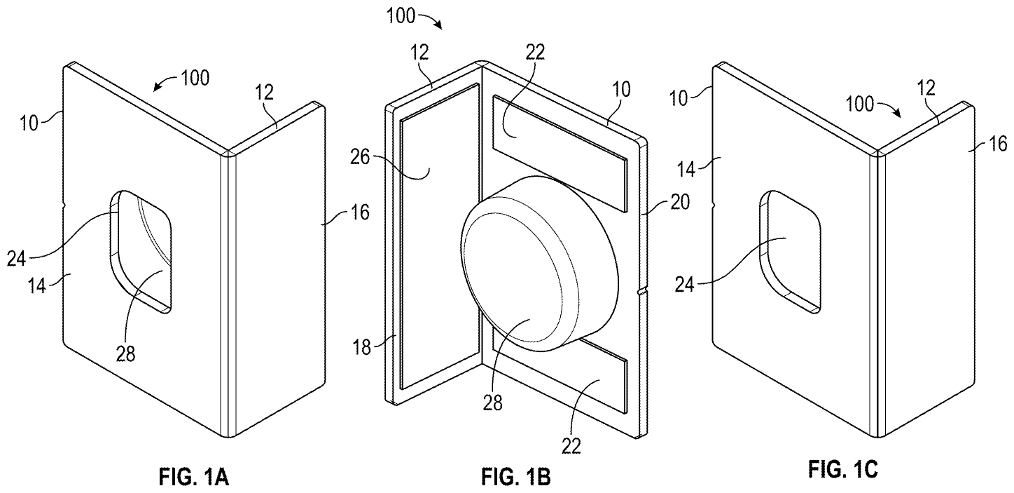

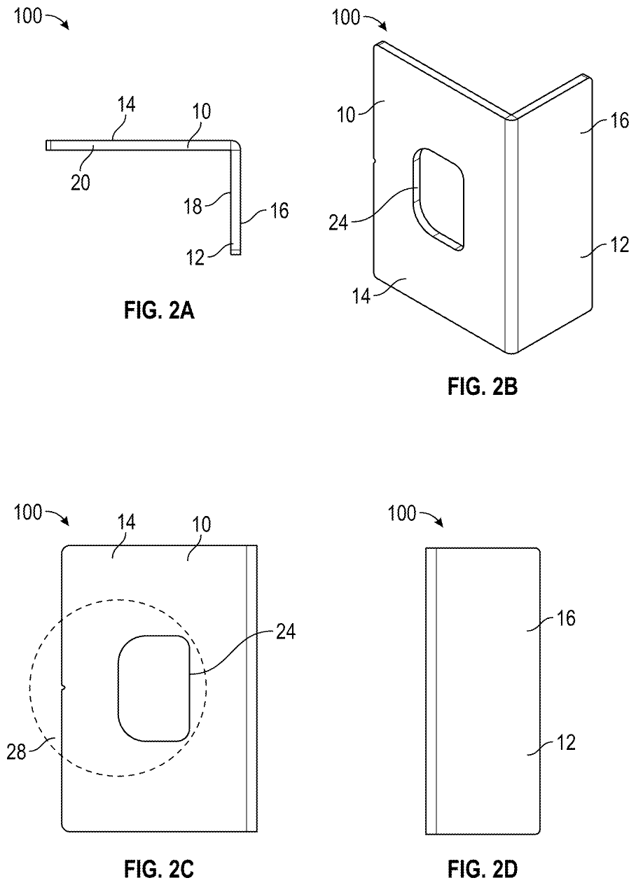

In some embodiments, as illustrated in FIGS. 1-2C and 3B, the strike plate assembly 100 includes a first member 10 and a second member 12 positioned substantially perpendicular to the first member 10. In certain embodiments, the first member 10 and the second member 12 are integrally or monolithically formed such that the strike plate assembly 100 is a single component. In other embodiments, the first member 10 and the second member 12 need not be integrally formed. The first member 10 may include a first surface 14, a second surface 20 opposite the first surface 14, and at least one aperture 24. The first member 10 may further include at least one first attachment member 22. The at least one first attachment member 22 may be disposed on the second surface 20 of the first member 10. As illustrated in FIG. 1B, the first member 10 may include two first attachment members 22 disposed adjacent the at least one aperture 24. The at least one first attachment member 22 may be oriented in any suitable arrangements with respect to the at least one aperture 24. For example, as illustrated in FIG. 1B, the first member 10 may include one first attachment member 22 disposed above the at least one aperture 24 and one first attachment member 22 disposed below the at least one aperture 24. However, depending on the needs or desires of a manufacturer or user, the at least one first attachment member 22 may be oriented in any other suitable arrangement on the second surface 20 of the first member 10. For example, suitable arrangements include, but are not limited to positioning the first attachment member on one or both sides of the at least one aperture 24, completely or partially around the at least one aperture 24, or in one or more corners of the second surface 20 of the first member 10. The first member 10 may have dimensions that range between 0.25 inches and 4 inches, inclusive, and may have any suitable value within or outside that range.

The at least one first attachment member 22 may be any suitable attachment means for securing the first member to the door frame 102. For example, the at least one first attachment member 22 may include, but is not limited to, tape, adhesive, hook and loop fastener, or any other suitable attachment means. It will be appreciated by those having ordinary skill in the art that the at least one first attachment member 22 may be any size, shape, or combination of sizes and shapes sufficient to meet the design requirements for binding the second surface 20 of the first member 10 to the intended surface.

As illustrated in FIGS. 1A-3A, the strike plate assembly 100 may further include a second member 12 oriented approximately perpendicular the first member 10. The second member 12 may include a first surface 16 and a second surface 18 opposite the first surface 16.

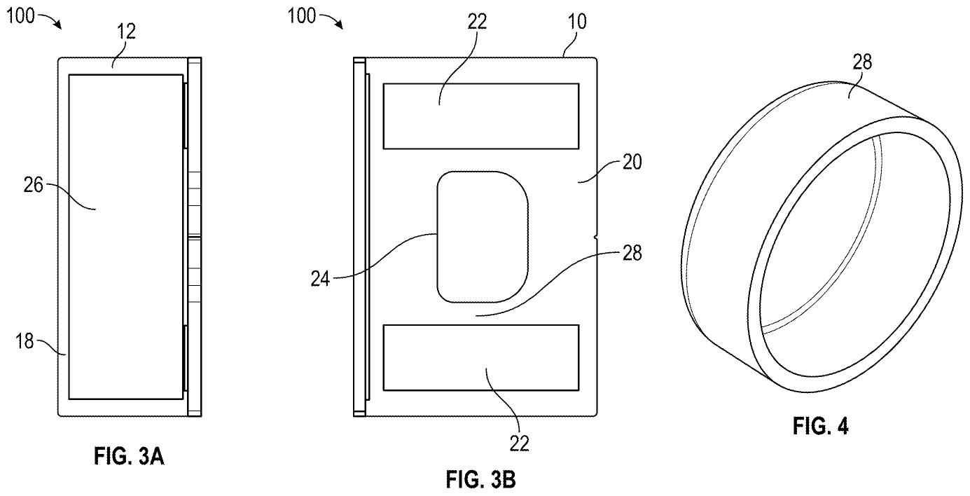

The second member 12 may further include at least one second attachment member 26 disposed on the second surface 18. The at least one second attachment member 26 may be sized such that the second attachment member 26 covers substantially all of the second surface 18 of the second member 12, as illustrated in FIGS. 1B and 3A. However, based on a manufacturer's or user's needs or desires, the at least one second attachment member 26 may be sized or shaped to cover only a portion of the second surface 18 of the second member 12. As previously described with respect to the first member 10, the second member 12 may include multiple second attachment members 26 arranged in any suitable arrangement on the second surface 18 of the second member 12.

As previously described with respect to the first attachment member 22, the at least one second attachment member 26 may be any suitable attachment means for securing the second member 12 to the door frame 102. For example, the at least one second attachment member 26 may include, but is not limited to, tape, adhesive, hook and loop fastener, or any other suitable attachment means. It will be appreciated by those having ordinary skill in the art that the at least one second attachment member 26 may be any size, shape, or combination of sizes and shapes sufficient to meet the design requirements for binding the second surface 18 of the second member 12 to the intended surface.

The second member 12 may have dimensions that range between .25 inches and 4 inches, inclusive, and may have any suitable value within or outside that range. As illustrated in FIGS. 1A-1C and 3A-3B, the second member 12 may be sized or shaped to have different dimensions than the dimensions of the first member 10. However, depending upon a user's or manufacturer's needs or desires, the first member 10 and the second member 12 may be sized or shaped to have substantially the same dimensions. It should also be appreciated that, while both the first member 10 and the second member 12 in FIGS. 1A-1C and 3A-3B have a rectangular shape, first member 10 and second member 12 may have any shape suitable for a particular design, which may or may not be the same shape.

As previously described, the first member 10 may be oriented approximately perpendicular to the second member 12. As such, an angle may be formed between the first member 10 and the second member 12, wherein the angle may be approximately 90°. However, depending on a user's or manufacturer's needs or wants, the angle may vary to be greater than or less than 90° to accommodate different door frame geometries, aesthetics, or other design factors. For example, in some embodiments, the second member 12 may comprise a curved extension of first member 10 that terminates at an oblique angle with respect to the first member 10, so as to allow a spring-loaded door latch, including spring latches, dead latches, ball catches, and roller catches, affixed to a door to more easily transition from an extended position to a retracted position as the door is closed. As a further example, the second member 12 may comprise a curved extension of the first member 10 (not shown) and an additional member (as shown in FIGS. 1A-2B and 6B) that mates with the contour of the door frame, which, depending on the door frame geometry, may or may not be approximately perpendicular to the first member 10. Such a configuration has the benefit of both accommodating a spring-loaded door latch as well as providing additional surface area for attachment of the strike plate assembly 100 to the door frame. The additional surface area provided by such a second member 12 (with or without a curved extension), in addition to allowing the strike plate assembly 100 to be more firmly secured to the door frame, counteracts the pushing force of the door latch on the curved surface, which thereby causes a moment that would otherwise exert a pulling force on the first member 10 and, over time (i.e., after many openings and closings of the door), weaken the bond between first member 10 and the door jamb.

Each of the first member 10 and the second member 12 may be formed of any suitable material, including but not limited to, metals such as aluminum, steel, stainless steel, brass, bronze, and nickel, durable polymers such as acrylonitrile butadiene styrene (ABS) and polydicyclopentadiene (PDCPD), and composites.

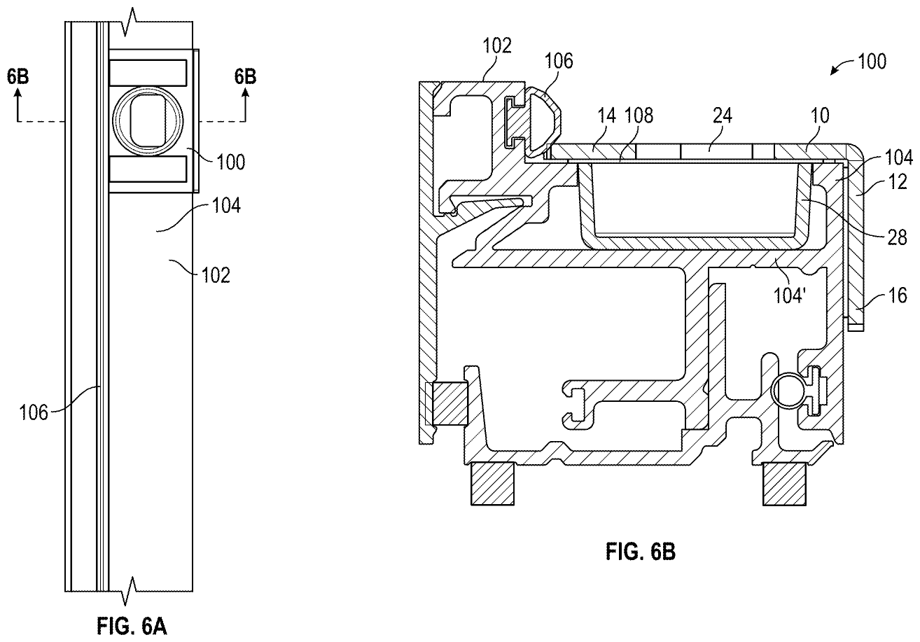

In some embodiments, the strike plate assembly 100 further includes a cover member 28, also referred to as a strike cup. While the cover member 28 is illustrated in the figures as being cup-shaped, in other embodiments, the cover member 28 may be open on both ends. The cover member 28 may be disposed on the second surface 20 of the first member 10. The cover member 28 may be positioned to cover the at least one aperture 24. As illustrated in FIG. 6B, the cover member 28 may positioned between the second surface 20 of first member 10 and an interior structure of the door frame 102. Therefore, when the strike plate assembly 100 is installed, the cover member 28 may prevent one or more views of the interior of the door frame 102.

The cover member 28 may be secured in various ways, including one or more of the following examples.

In some examples, the cover member 28 may be secured between the second surface 20 of the first member 10 and the interior of the door frame 102 by a pressure that is applied when the first member 10 is secured to the door frame 102. The cover member 28 may be secured to the door frame 102 via one or more lips extending outwards from one or more edges of the cover member 28, wherein the one or more lips are coupled to or otherwise configured to contact or engage the exterior structure of the door frame 102. The lips may be coupled to the door frame 102 via any suitable attachment means, including, but not limited to, adhesive, hook and loop fastener, magnets, or any other suitable attachment means. Additionally, the one or more lips may be sandwiched between the second surface 20 of the first member 10 and the exterior structure of the door frame 102. In some embodiments, the one or more lips of the cover member 28 may be wholly or partially recessed into the door frame 102.

In other embodiments, the cover member 28 may be secured to the door frame 102 by frictional fit with one or more apertures in the door frame 102. The cover member 28 may be secured to the door frame 102 by one or more protrusions extending from one or more sides of cover member 28 that engage with one or more apertures in the door frame 102. For example, such protrusions of cover member 28 may comprise ball bearings or other anchors that retract as the cover member 28 is moved through an aperture of door frame 102 and extend after passing through the aperture. Such retraction and extension of the anchors may result from spring-loaded mechanisms, affixing the anchors to flexible slits in the side of the cover member 28, or any other mechanisms that exert an elastic force on the anchors. The cover member 28 may be secured by attachment to the interior structure of the door frame 102 via any suitable attachment means, including, but not limited to, adhesive, hook and loop fastener, magnets, or any other suitable attachment means. The cover member 28 may be secured through attachment to the second surface 20 of the first member 10 via any suitable attachment means, including adhesive, hook and loop fastener, magnets, or any other suitable attachment means. While the cover member 28 is illustrated as a separate structure, the cover member 28 may be integrally or monolithically formed with the first member 10 such that cover 28 and strike plate assembly 100 are a single component depending on a user's or manufacturer's needs or desires.

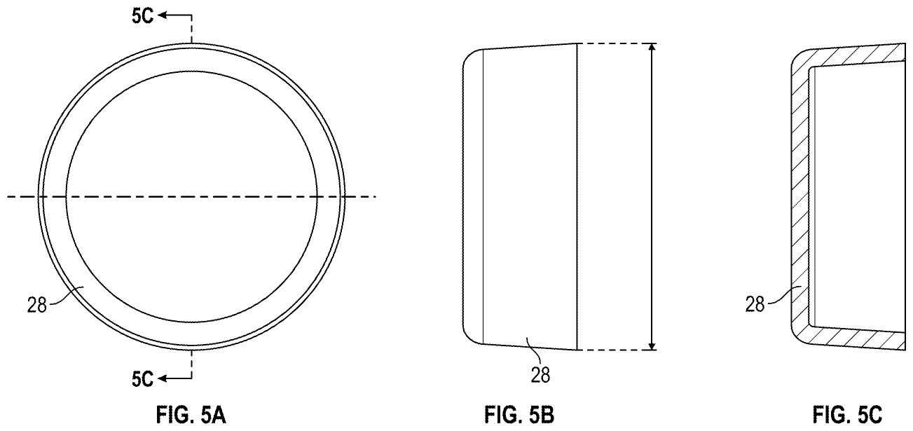

As illustrated in FIGS. 1B and 4-6B, the cover member 28 may be formed as having a circular cross-section, which facilitates installation (discussed below in further detail) and stabilization of the cover member 28 by matching the circular shape of cover member 28 to the circular shape of an aperture 108 made by a drill or hole saw. However, the cover member 28 may be formed to have any suitable shape or cross-section as desired. For example, possible shapes of the cover member include, but are not limited to, cylindrical, frustoconical, and frustopyramidal, and possible cross-sections of the cover member 28 include circular, oval, elliptical, polygonal, and freeform, or any other suitable shape. Moreover, the cover member 28 may be sized to have dimensions that range between 0.25 inches and 4 inches, and may have any suitable value within or outside that range.

In some embodiments, the door frame 102 includes a gasket member 106. The gasket member 106 may be positioned within the door frame 102 such that the gasket member 106 contacts the first member 10 when the strike plate assembly 100 is installed. Moreover, the gasket member 106 may provide a surface against which the door may contact during operation (i.e., opening or closing). The gasket member 106 may be formed to be any suitable shape and may further have any suitable dimensions.

A method for installing the strike plate assembly 100 will now be described in greater detail. The method for installing the strike plate assembly 100 may include positioning the strike plate assembly 100 along the door frame 102. To determine the location of the strike plate assembly 100 along the door frame 102, a user may open and close the door to ensure that the door is in the proper position and works as intended. With the door in a nearly closed position, a user may mark a vertical center of the strike plate assembly 100 where the strike plate assembly 100 intersects with the door frame 102. A user may then measure from an outer edge opposite the gasket member 106 to indicate a center mark. In some embodiments, a user may measure within a range of approximately 0.5 inches to 1.2 inches, inclusive. A user may then easily drill or cut, e.g., using a hole saw, a door frame aperture 108 within the door frame 102. The door frame aperture 108 may be formed at a location that corresponds with the center mark. To form the door frame aperture 108, a user may, for example, use a hole saw to cut a hole thereby forming the door frame aperture 108. In some embodiments, the hole saw may be a 1⅜ inch hole saw. However, the particular size of the hole saw may vary depending upon a user's or manufacturer's needs or desires. Further, the door frame aperture 108 may be formed such that the door frame aperture 108 has a depth equal to the distance between a first surface 104 of the door frame 102 and a second surface 104′ beneath the first surface 104. A user may then position the cover member 28 within the door frame aperture 108 such that the cover member 28 is substantially flush with the first surface 104 of the door frame 102.

The strike plate assembly 100 may then be installed on or within the door frame 102. For example, the strike plate assembly 100 may be installed on top of the door frame 102 as shown in FIGS. 6A-6B. In various embodiments, the strike plate assembly 100 may be installed within a recess in the door frame 102 (not shown). In such embodiments, the recess need only be large enough to accommodate the strike plate assembly 100 and may or may not correspond to the shape of the strike plate assembly 100. A user may activate the at least one first attachment member 22 and the at least one second attachment member 26. For example, as previously described, each of the at least one first attachment member 22 and the at least one second attachment member 26 may be formed of adhesive, including two-sided acrylic foam tape, two-sided polyester film tape, or any other suitable “double-sided” tape (i.e., any product comprising an adhesive layer applied to each side of a carrier substrate material). In cases where the first attachment member 22 and the second attachment member 26 are formed of a tape adhesive such as double-sided tape, activating the at first attachment member 22 and the second attachment member 26 may include a user removing a liner, for example, a glassine paper liner, of the tape. In other examples, activating the first attachment member 22 and the second attachment member 26 may include applying liquid adhesive to a first member 10 and the second member 12 or surfaces of the door frame 102.

A user may then clean a surface surrounding the door frame aperture 108. In some embodiments, a user may clean the surfaces surrounding the door frame aperture 108 that will be contacted by the adhesive. Such surfaces may be cleaned by using an isopropyl alcohol (IPA) mix, for example, 99% alcohol and 1% water. When ready, a user may position the strike plate assembly 100 along the door frame 102 such that the aperture 24 of the strike plate assembly 100 is aligned with the door frame aperture 108 and, when the strike plate assembly 100 is secured in place, a latch may pass over the strike plate assembly 100 and into the cover member 28. Once positioned, a user may apply pressure to the first surface 14 of the first member 10 and the first surface 16 of the second member 12 thereby securing the strike plate assembly 100 to the door frame 102.

Different arrangements of the components depicted in the drawings or described above, as well as components and steps not shown or described, are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

That which is claimed is:

1. A strike plate assembly configured to be installed in a door frame comprising:
a first member comprising:
a first surface;
a second surface opposite the first surface;
at least one first attachment member disposed on the second surface; and
at least one aperture;
a second member comprising:
a first surface;
a second surface opposite the first surface; and
at least one second attachment member disposed on the second surface;
a cover member positioned on the second surface of the first member such that the cover member substantially covers the at least one aperture;
wherein the first member is positioned substantially perpendicular to the second member; and
wherein, when installed, the at least one first attachment member attaches the first member to a door frame first surface, and the at least one second attachment member attaches the second member to a door frame second surface.

2. The strike plate assembly of claim 1, further comprising a gasket disposed on the door frame, wherein, when installed, the gasket contacts the first member.

3. The strike plate assembly of claim 1, wherein the first member has a first length and the second member has a second length, and the first length is greater than the second length.

4. The strike plate assembly of claim 1, wherein the first member comprises two first attachment members.

5. The strike plate assembly of claim 4, wherein one of the two first attachment members is positioned above the at least one aperture and another of the two first attachment members is positioned below the at least one aperture.

6. The strike plate assembly of claim 1, wherein each of the at least one first attachment member and the at least one second attachment member is an adhesive attachment.

7. The strike plate assembly of claim 1, wherein, when installed, the cover member is positioned within the at least one aperture.

8. A strike plate assembly for a door frame comprising:
a first member positioned substantially perpendicular to a second member;
wherein the first member comprises:
an exterior surface;
an interior surface opposite the exterior surface;
at least one aperture;
wherein the second member comprises:
an exterior surface;
an interior surface opposite the exterior surface; and
wherein an angle between the first member and the second member is approximately 90 degrees.

9. The strike plate assembly of claim 8, further comprising a gasket disposed on the door frame, wherein, when installed, the gasket contacts the first member.

10. The strike plate assembly of claim 8, wherein the first member has a first length and the second member has a second length, and the first length is greater than the second length.

11. The strike plate assembly of claim 8, wherein the first member comprises two first attachment members.

12. The strike plate assembly of claim 11, wherein one of the two first attachment members is positioned above the at least one aperture and another of the two first attachment members is positioned below the at least one aperture.

13. The strike plate assembly of claim 8, wherein an adhesive attachment is configured to join the interior surface of the first member and the interior surface of the second member to the door frame.

14. A method for installing a strike plate assembly comprising a first member having at least one aperture, a second member positioned substantially perpendicular the first member, and at least one attachment member, on a door frame comprising:
forming an aperture within a surface of the door frame;
positioning the strike plate assembly on the door frame such that the at least one aperture is positioned over the aperture formed within the door frame; and
applying pressure to the strike plate assembly to secure the strike plate assembly to the door frame via the at least one attachment member.

15. The method of claim 14, wherein the at least one attachment member includes at least one first attachment member disposed on the first member, and at least one second attachment member disposed on the second member.

16. The method of claim 14, further comprising positioning a cover member within the aperture formed within the door frame.

15. The method of claim 14, wherein each of the at least one first attachment member and the at least one second attachment member is an adhesive attachment.

16. The method of claim 14, wherein positioning the strike plate assembly on the door frame includes positioning the first member of the strike plate assembly on the door frame.

17. The method of claim 14, wherein applying pressure to the strike plate assembly includes applying pressure to a surface of the first member to secure the first member to a door frame first surface.

18. The method of claim 14, wherein applying pressure to the strike plate assembly includes applying pressure to a surface of the second member to secure the second member to a door frame second surface.
